(19) United States
(12) Patent Application Publication
(10) Pub. No.: US 2009/0078266 A1
(43) Pub. Date: Mar. 26, 2009

(54) FILTERING FACE-PIECE RESPIRATOR HAVING BUCKLES INTEGRAL TO THE MASK BODY SUPPORT STRUCTURE

(75) Inventors: Daniel J. Stepan, St. Paul, MN (US); Philip G. Martin, Forest Lake, MN (US); Yonas Gebrewold, Woodbury, MN (US); Francesco Lovo, Giaveno (IT); Dan Mattano, Turin (IT); Claudio Ponzio, Turin (IT)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/193,927

(22) Filed: Aug. 19, 2008

Related U.S. Application Data
(60) Provisional application No. 60/974,031, filed on Sep. 20, 2007.

(51) Int. Cl. A62B 23/02; A62B 18/02

(52) U.S. Cl. 128/206.19; 128/206.21

(57) ABSTRACT

A filtering face-piece respirator 10 that includes a mask body 12 and a harness 14 and a support structure 16. The support structure 16 has a perimeter 20 that includes buckles 40 that are integrally joined to the perimeter 20. A mask body of this construction avoids the need to separately make the buckles and the mask body support structure and avoids an additional step in the assembly of the respirator.

### CROSS-REFERENCE TO RELATED APPLICATION

This application claims the benefit of U.S. Provisional Patent Application No. 60/974,031, filed Sep. 20, 2007.

The present invention pertains to a filtering face-piece respirator that has a mask body that enables strap adjustment buckles to be manufactured integrally with the mask body support structure.

### BACKGROUND

Respirators are commonly worn over the breathing passages of a person for at least one of two common purposes: (1) to prevent impurities or contaminants from entering the wearer's breathing track; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

Some respirators are categorized as being “filtering face-pieces” because the mask body itself functions as the filtering mechanism. Unlike respirators that use rubber or elastomeric mask bodies in conjunction with attachable filter cartridges (see, e.g., U.S. Pat. No. RE39,493 to Yuschak et al.) or insert-molded filter elements (see, e.g., U.S. Pat. No. 4,790,306 to Braun), filtering face-piece respirators have the filter media cover much of the whole mask body so that there is no need for installing or replacing a filter cartridge. As such, filtering face-piece respirators are relatively light in weight and easy to use. Examples of patents that disclose filtering face-piece respirators include U.S. Pat. No. 7,131,442 to Kronzer et al, U.S. Pat. Nos. 6,923,182 and 6,041,782 to Angadjivand et al. U.S. Pat. Nos. 6,568,392 and 6,484,722 to Bostock et al., U.S. Pat. No. 6,394,090 to Chen, U.S. Pat. No. 4,873,972 to Magidson et al., U.S. Pat. No. 4,850,347 to Skov, U.S. Pat. No. 4,807,619 to Dyrud et al., U.S. Pat. No. 4,536,440 to Berg, and U.S. Pat. Des. No. 285,374 to Huber et al.

To provide a filtering face-piece respirator that has a permanent cup-shaped configuration, the mask body is typically provided with a molded shaping layer. Molded shaping layers have been made from webs of thermally bonded fibers or open-work filamentary plastic meshes, which webs and meshes are molded into the cup-shaped configuration. These shaping layers are used to support the filtering structure, which often comprises an electrically-charged nonwoven web of microfibers.

Typically, one or more elastic straps are used to hold the filtering face-piece respirator snugly against the wearer's face. These straps are commonly adhered, welded, or stapled directly to the mask body. Some filtering face-piece respirators, however, use buckles to allow the strap length to be adjusted. The buckles too are adhered, welded, or stapled to the mask body. The 3M 8212 and 8293 filtering face-piece respirators, for example, use staples to attach the buckles to the mask body. One particular drawback that conventional filtering face-piece respirators exhibit is that the buckles need to be manufactured separately from the shaping layer and filter media of the mask body. Further, an additional manufacturing step is needed to secure the buckle to the respirator.

### SUMMARY OF THE INVENTION

The present invention overcomes the drawback of providing strap adjustment buckles separate from the other parts of the mask body. As indicated above, conventional filtering face-piece respirators have generally used webs of thermally bonded fibers or open-work filamentary plastic meshes as shaping layers for supporting the filter media. These existing support structures have not, however, been amenable to having the strap adjustment buckles manufactured at the same time as the shaping layer. Conventional filtering face-piece respirators have therefore required that the buckles be made separately from the shaping layer and that a manufacturing step—such as adhering, welding, or stapling—be employed to secure the buckle to the mask body.

The present invention provides a new mask body construction, that enables the strap adjustment buckles to be manufactured at the same time as the mask body support structure. The present invention provides a filtering face-piece respirator that comprises (a) a mask body that comprises: (i) a filtering structure; (ii) a support structure that includes a perimeter member that is sized to enable a first buckle to be integrally joined thereto; (iii) a first strap that is threaded through the first buckle.

The present invention also provides a new method of making a filtering face-piece respirator, which method comprises (a) providing a mask body that comprises a support structure that has at least one buckle integrally joined thereto; (b) supporting a filtering structure within the mask body; and (c) providing a strap that can be threaded through the buckle and that can be adjusted in length.

Conventional filtering face-piece respirators have had the buckles secured to the fibrous and open-work plastic support structures of the mask body through use of an adhesive, staples, or a weld. These known mask body construction techniques required additional parts and process steps to complete the respirator harness assembly. Because conventional filtering face-piece mask bodies have regularly used shaping layers that comprised molded nonwoven webs of thermally-bonded fibers or open-work filamentary meshes to provide structural integrity to the mask body, the ability to provide an integral adjustment buckle was lacking. The present invention eliminates the need for these additional parts and manufacturing steps by using a buckle that is integral to the mask body support structure.

### Glossary

The terms set forth below will have the meanings as defined:

“bisect(s)” means to divide into two generally equal parts;

“buckle” means a part that allows a harness strap to be threaded therethrough such that the strap length can be adjusted;

“centrally spaced” means separated significantly from one another along a line or plane that bisects the mask body vertically;

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the inventive respirator in serving its intended function;

“clean air” means a volume of atmospheric ambient air that has been filtered to remove contaminants;

“contaminants” means particles (including dusts, mists, and fumes) and/or other substances that generally may not be considered to be particles (e.g., organic vapors, et cetera) but which may be suspended in air, including air in an exhale flow stream;

“crosswise dimension” is the dimension that extends laterally across the respirator from side-to-side when the respirator is viewed from the front;

“elastic” means having the ability to return to its initial form or state after being stretched to 100% or more of its initial length;

“exhalation valve” means a valve that opens to allow a fluid to exit a filtering face mask's interior gas space;

“exterior gas space” means the ambient atmospheric gas space into which exhaled gas enters after passing through and beyond the mask body and/or exhalation valve;

“filtering face-piece” means that the mask body itself is designed to filter air that passes through it; there are no separately identifiable filter cartridges or insert-molded filter elements attached to or molded into the mask body to achieve this purpose;

“filter” or “filtration layer” means one or more layers of air-permeable material, which layer(s) is adapted for the primary purpose of removing contaminants (such as particles) from an air stream that passes through it;

“filtering structure” means a construction that is designed primarily for filtering air;

“first side” means an area of the mask body that is laterally distanced from a plane that bisects the mask vertically and that would reside in the region of a wearer's cheek and/or jaw when the respirator is being donned;

“harness” means a structure or combination of parts that assists in supporting the mask body on a wearer's face;

“integral” means being manufactured together at the same time; that is, being made together as one part and not two separately manufactured parts that are subsequently joined together;

“interior gas space” means the space between a mask body and a person's face;

“line of demarcation” means a fold, seam, weld line, bond line, stitch line, hinge line, and/or any combination thereof;

“living hinge” means a mechanism that allows members that extend therefrom to generally pivot thereabout in a rotational-type manner with such ease that significant damage is not caused to the members or to the hinge joint;

“mask body” means an air-permeable structure that is designed to fit over the nose and mouth of a person and that helps define an interior gas space separated from an exterior gas space;

“member”, in relation to the support structure, means an individually and readily identifiable solid part that is sized to contribute significantly to the overall construction and configuration of the support structure;

“perimeter” means the outer edge of the mask body, which outer edge would be disposed generally proximate to a wearer's face when the respirator is being donned by a person;

“polymeric” and “plastic” each mean a material that mainly includes one or more polymers and may contain other ingredients as well;

“plurality” means two or more;

“respirator” means an air filtration device that is worn by a person to provide the wearer with clean air to breathe;

“rigid” means the part does not readily deform substantially and easily in response to mere pressure from a person's finger.

“second side” means an area of the mask body that is distanced from a plane line that bisects the mask vertically (the second side being opposite the first side) and that would reside in the region of a wearer's cheek and/or jaw when the respirator is being donned;

“support structure” means a construction that is designed to have sufficient structural integrity to retain its desired shape, and to help retain the intended shape of the filtering structure that is supported by it, under normal handling;

“spaced” means physically separated or having measurable distance therebetween; and

“transversely extending” means extending generally in the crosswise dimension.

### BRIEF DESCRIPTION OF THE DRAWINGS

FIG. 1 shows a front perspective view of a filtering face-piece respirator 10, in accordance with the present invention, being worn on a person's face;

FIG. 2 is a side view of filtering face-piece respirator 10 in accordance with the present invention;

FIG. 3 is a front view of a filtering face-piece respirator 10;

FIGS. 4a and 4b are enlarged front and rear views of the buckle/strap combination; and

FIG. 5 is a cross-sectional view of a filtering structure 18 that may be used in a mask body of the present invention.

### DETAILED DESCRIPTION OF PREFERRED EMBODIMENTS

In practicing the present invention, a filtering face-piece respirator is provided that has an integral buckle attached to the support structure of the mask body. Rather than using a conventional shaping layer that comprises thermally-bonded fibers or an open-work plastic mesh to support an exhalation valve, the present invention comprises a different structure for this purpose. The new support structure is particularly beneficial in that it provides a solid surface onto which an adjustment buckle can be integrally joined. The use of an integral buckle eliminates the need for separately manufacturing the buckle and for subsequently joining the buckle to the mask body by adhering, welding, or stapling. The integral buckle also allows the strap to be adjusted in length so that tension can be altered to suit the wearer.

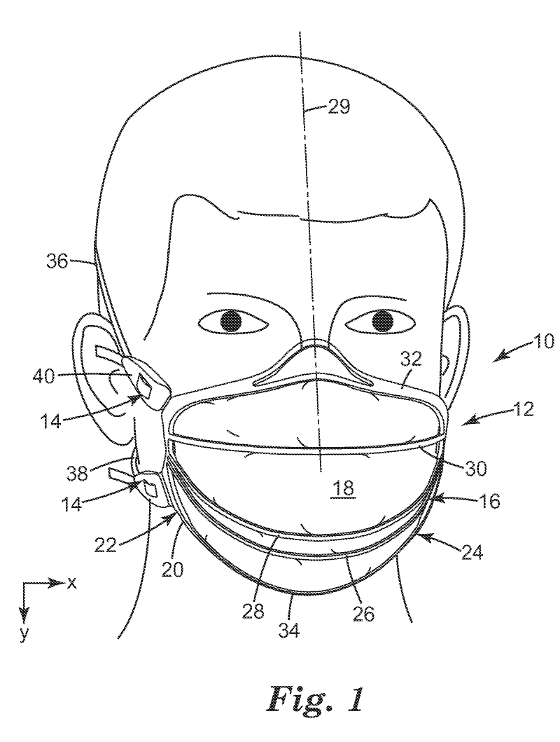

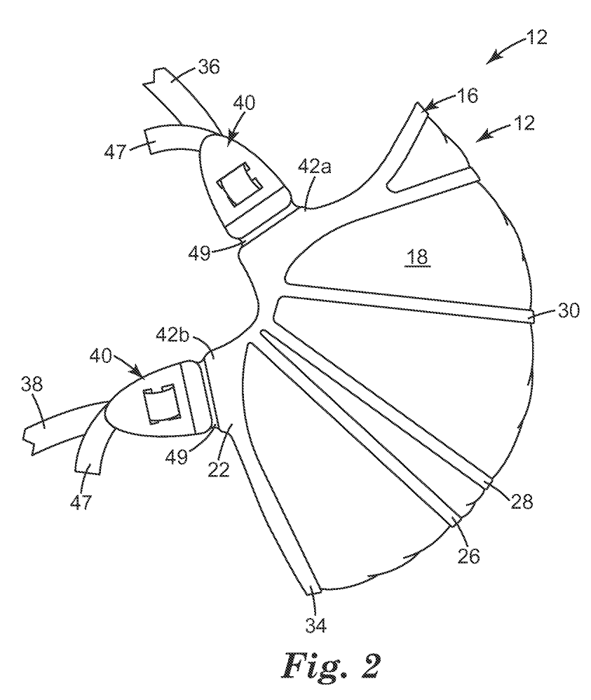

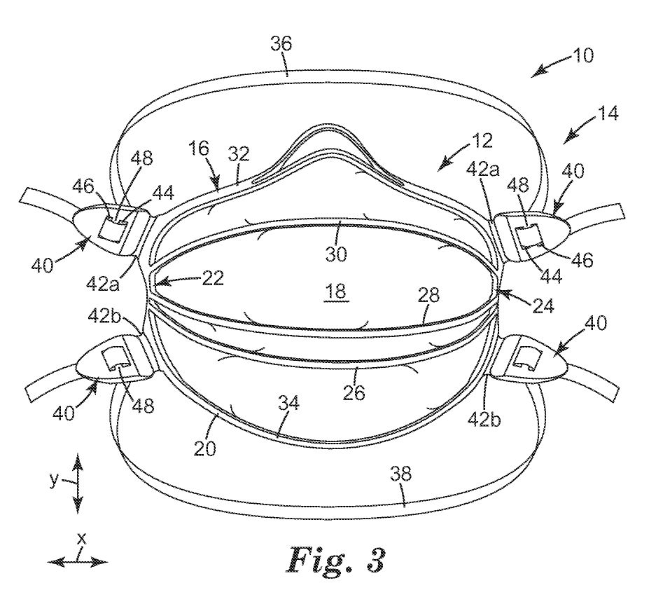

FIGS. 1-3 show an example of a filtering face-piece respirator 10 that may be used in accordance with the present invention. As illustrated, the filtering face-piece respirator 10 includes a mask body 12 and a harness 14. The mask body 12 has a support structure 16 and a filtering structure 18. The support structure 16 includes a perimeter 20, a first side 22, and an opposing second side 24. The perimeter 20 of the support structure 16 may, but not necessarily, contact the wearer's face when the respirator 10 is being donned. The perimeter 20 may comprise a member, or combination of members, that extend 360° continuously about, and adjacent to, the periphery of the mask body 12. Typically, the wearer's face will contact only the inner surface of the periphery of the filtering structure 18 or an additional face seal material. Thus, the peripheral edge of the filtering structure 18 may project radially beyond the perimeter 20 of the support structure 16. The support structure 16 also includes transversely-extending members 26, 28, and 30. The transversely-extending members 26, 28, and 30 extend from a first side 22 of the mask body 12 to a second side 24. The invention, however, does contemplate embodiments where the transversely-extending members do not need to extend fully across the mask body 12. One or more members also could extend in the longitudinal dimension between the top perimeter member 32 and the bottom perimeter member 34. When viewing the respirator as projected onto a plane from the front (FIG. 3), the transverse direction is the direction that extends across the respirator in the general “x” direction, and the longitudinal direction is the dimension that extends between the bottom and top of the respirator 10 in the general “y” direction. One or more of the transversely-extending members and/or peripheral members may expand or contract longitudinally to better accommodate wearer jaw movement and various sized faces—see U.S. Patent Application Ser. No. 60/974,025, entitled Filtering Face-Piece Respirator that Has Expandable Mask Body, filed Sep. 20, 2007 (attorney docket number 63165US002). The transversely-extending members, longitudinally-extending members, and peripheral members may be sized to have cross-sectional areas that are about 2 to 12 mm² in size, more typically about 4 to 8 mm² in size. The respirator 10 can be supported on the face of the wearer by the harness 14 that includes first and second straps 36 and 38. These straps 36, 38 may be adjusted in length by one or more buckles 40. The buckles 40 are integrally secured to the mask body 12 at the first and second sides 22, 24 at hamess-securement flange members 42a, 42b. Although the drawings show a respirator 10 that has four buckles secured to the mask body, it may be possible to use a lesser number of buckles. For example, it may be possible to use only one strap; whereby, the strap is mounted directly to the mask body on one side and is joined to the mask body through a single buckle located on the other side. In such an instance, the strap length would only be adjusted on one side of the mask body rather than on both sides. Alternatively, a single strap construction could be used, whereby a single buckle is located on first and second sides of the mask body. In another embodiment, two buckles 40 may be used on the mask body with two straps; whereby, each strap is secured directly to the respirator on one side and is secured to the respirator on another side through a buckle 40. Or as shown in the drawings, four buckles may be used to provide four strap adjustment points between two straps.

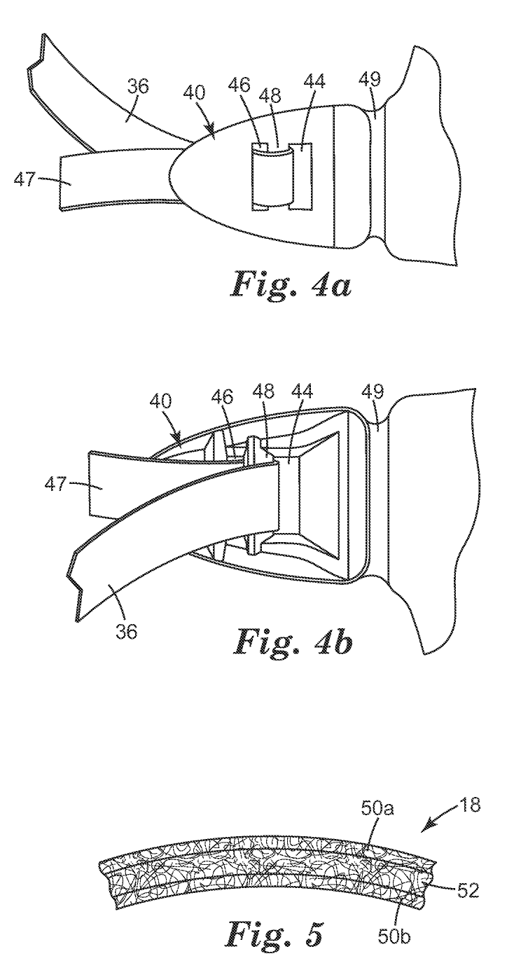

FIGS. 4a and 4b show the buckles in an enlarged format to better illustrate how the strap 36 can be threaded through first and second slots 44 and 46. The buckle also includes a cinch bar 48, which can grip the strap 36 when tension is exerted on the strap from behind the wearer's hand. When such tension is removed, the strap may be pushed through the slots to achieve the desired length. FIGS. 4a-4b also show how each of the slots 44 and 46 are preferably sized and located relative to the cinch bar such that the strap can be pulled on at the free end 47 relatively easily so that strap length can be shortened. When the strap is pulled on in the other direction by grasping the strap between the first and second sides 22, 24 of the mask body 12, the strap frictionally grasps the cinch bar so that strap length is preserved and the desired tension can be applied to support the respirator 10 snugly against the wearer's face. To decrease tension by increasing strap length between each side of the mask body, the strap may be pulled on between first and second slots 44 and 46 to create a loop that is then fed through slot 49. Alternatively, the buckle 40 can be forced away from the strap portion 36 that extends between the first and second sides of the mask body. When the respirator 10 is being worn, the strap 36 is generally parallel to the buckle 40. If the buckle 40 is displaced at an angel of about 30° to 90°, however, the strap 36 can be drawn through slots 46 and 44 to increase the strap length between the first and second sides of the mask body. The buckles may be joined to the perimeter member(s) 20 (FIG. 3) at one or more living hinges 49, which enable the buckle 40 to rotate about the hinge so that it can bend towards the side of the wearer's face when the respirator is being donned. The living hinge 49 may also allow the buckle 40 to project away from the mask body so that the wearer can easily make the desired strap length adjustment. Examples of various buckles that may be used in conjunction with the present invention include the buckles described in the following patents: U.S. Pat. No. 7,185,653B2 to Lee, U.S. Pat. No. 7,155,786B2 to Grimm, U.S. Pat. No. 6,247,210B1 to Hamilton, U.S. Pat. No. 4,843,689 to Fildan, U.S. Pat. No. 4,571,783 to Kasai, U.S. Pat. Nos. 4,525,901 and 4,395,803 to Krauss, U.S. Pat. No. 4,171,555 to Bakker et al., and GB970,611 to Wilson.

The buckles and/or support structure may be made by known techniques such as injection molding. Known plastics such as olefins including, polyethylene, polypropylene, polybutylene, and polymethyl(pentene); plastomers; thermoplastics; thermoplastic elastomers; and blends thereof may be used to make the buckle and/or support structure. Additives such as pigments, UV stabilizers, anti-block agents, nucleating agents, fungicides, and bactericides also may be added to the composition that forms the buckle and/or support structure. The plastic typically exhibits a flexural modulus of about 75 to 300 Mega Pascals (MPa), more typically about 100 to 250 MPa, and still typically about 175 to 225 MPa. A plastic used for the support structure can be selected to exhibit resilience, shape memory, and resistance to flexural fatigue so that the support structure and buckle attachment can be deformed to accommodate proper fitting and strap tension forces. The support structure members may be rectangular, circular, triangular, elliptical, trapezoidal, etc., when viewed in cross-section. A metal or ceramic material also may be used in lieu of plastic to construct the buckle and/or support structure, although a plastic may be preferred for disposal/cost reasons. The support structure is a part or assembly that is not integral to (or made together with) the filtering structure and comprises members that are sized to be larger than the fibers used in the filtering structure.

The straps that are used in the harness may be made from a variety of materials, such as thermoset rubbers, thermoplastic elastomers, braided or knitted yarn/rubber combinations, inelastic braided components, and the like. The straps may be made from an elastic material such as an elastic braided material. The strap preferably can be expanded to greater than twice its total length and be returned to its relaxed state. More preferably, the strap can be increased to three or four times its relaxed state length and be returned to its original condition without any damage thereto when the tensile forces are removed. The elastic limit thus is preferably not less than two, three, or four times the length of the strap when in its relaxed states. Typically, the straps are about 25 to 60 cm long, to 5 to 10 mm wide, and 0.9 to 1.5 mm thick. The straps may extend from the first buckle to a second buckle on an opposing side of the mask body as a continuous strap or the strap may have a plurality of parts, which can be joined together by further fasteners or buckles. For example, the strap may have first and second parts that are joined together by a fastener that can be quickly uncoupled by the wearer when removing the mask body from the face. An example of a strap that may be used in connection with the present invention is shown in U.S. Pat. No. 6,332,465 to Xue et al. Examples of fastening or clasping mechanism that may be used to joint one or more parts of the strap together is shown, for example, in the following U.S. Pat. No. 6,062,221 to Brostrom et al., U.S. Pat. No. 5,237,986 to Seppala, and EP1,495,785A1 to Chien.

FIG. 4 shows a cross-section of the filtering structure 18. As illustrated, the filtering structure 18 may include one or more cover webs 50a and 50b and a filtration layer 52. The cover webs 50a and 50b may be located on opposing sides of the filtration layer 52 to capture any fibers that could come loose therefrom. Typically, the cover webs 50a and 50b are made from a selection of fibers that provide a comfortable feel, particularly on the side of the filtering structure 18 that makes contact with the wearer's face. The construction of various filter layers and cover webs that may be used in conjunction with the support structure of the present invention are described below in more detail. To improve fit and wearer comfort, an elastomeric face seal can be secured to the perimeter of the filtering structure 18. Such a face seal may extend radially inward to contact the wearer's face when the respirator is being donned. Examples of face seals are described in U.S. Pat. No. 6,568,392 to Bostock et al., U.S. Pat. No. 5,617,849 to Springett et al., and U.S. Pat. No. 4,600,002 to Maryyanek et al., and in Canadian Patent 1,296,487 to Yard.

The filtering structure may take on a variety of different shapes and configurations. The filtering structure typically is adapted so that it properly fits against or within the support structure. Generally the shape and configuration of the filtering structure corresponds to the general shape of the support structure. The filtering structure may be disposed radially inward from the support structure, it may be disposed radially outward from the support structure, or it may be disposed between various members that comprise the support structure. Although a filtering structure has been illustrated with multiple layers that include a filtration layer and two cover webs, the filtering structure may simply comprise a filtration layer or a combination of filtration layers. For example, a pre-filter may be disposed upstream to a more refined and selective downstream filtration layer. Additionally, sorptive materials such as activated carbon may be disposed between the fibers and/or various layers that comprise the filtering structure. Further, separate particulate filtration layers may be used in conjunction with sorptive layers to provide filtration for both particulates and vapors. The filtering structure may include one or more stiffening layers that allow such a cup-shaped configuration to be maintained. Alternatively, the filtering structure could have one or more horizontal and/or vertical lines of demarcation that contribute to its structural integrity to help maintain the cup-shaped configuration.

The filtering structure that is used in a mask body of the invention can be of a particle capture or gas and vapor type filter. The filtering structure also may be a barrier layer that prevents the transfer of liquid from one side of the filter layer to another to prevent, for instance, liquid aerosols or liquid splashes from penetrating the filter layer. Multiple layers of similar or dissimilar filter media may be used to construct the filtering structure of the invention as the application requires. Filters that may be beneficially employed in a layered mask body of the invention are generally low in pressure drop (for example, less than about 195 to 295 Pascals at a face velocity of 13.8 centimeters per second) to minimize the breathing work of the mask wearer. Filtration layers additionally are flexible and have sufficient shear strength so that they generally retain their structure under expected use conditions. Examples of particle capture filters include one or more webs of fine inorganic fibers (such as fiberglass) or polymeric synthetic fibers. Synthetic fiber webs may include electret charged polymeric microfibers that are produced from processes such as meltblowing. Polyolefin microfibers formed from polypropylene that has been electrically charged provide particular utility for particulate capture applications. An alternate filter layer may comprise a sorbent component for removing hazardous or odorous gases from the breathing air. Sorbents may include powders or granules that are bound in a filter layer by adhesives, binders, or fibrous structures—see U.S. Pat. No. 3,971,373 to Braun. A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtration structure that may be conformed into various configurations is described in U.S. Pat. No. 6,391,429 to Senkus et al.

The filtration layer is typically chosen to achieve a desired filtering effect and, generally, removes a high percentage of particles and/or or other contaminants from the gaseous stream that passes through it. For fibrous filter layers, the fibers selected depend upon the kind of substance to be filtered and, typically, are chosen so that they do not become bonded together during the molding operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area—see, for example, U.S. Pat. Nos. 5,804,295 and 5,656,368 to Braun et al. The filtration layer also may include multiple filtration layers joined together by an adhesive or any other means. Essentially any suitable material that is known (or later developed) for forming a filtering layer may be used for the filtering material. Webs of melt-blown fibers, such as those taught in Wente, Van A., Superfine Thermoplastic Fibers, 48 Indus. Engn. Chem., 1342 et seq. (1956), especially when in a persistent electrically charged (electret) form are especially useful (see, for example, U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. Particularly preferred are BMF webs that contain fibers formed from polypropylene, poly(4-methyl-1-pentene), and combinations thereof. Electrically charged fibrillated-film fibers as taught in van Turnhout, U.S. Pat. No. Re. 31,285, may also be suitable, as well as rosin-wool fibrous webs and webs of glass fibers or solution-blown, or electrostatically sprayed fibers, especially in microfilm form. Electric charge can be imparted to the fibers by contacting the fibers with water as disclosed in U.S. Pat. No. 6,824,718 to Eitzman et al., U.S. Pat. No. 6,783,574 to Angadjivand et al., U.S. Pat. No. 6,743,464 to Insley et al., U.S. Pat. Nos. 6,454,986 and 6,406,657 to Eitzman et al., and U.S. Pat. Nos. 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 6,398,847 B1, 6,397,458 B1, and 6,409,806 B1 to Jones et al. Typical basis weights for electret BMF filtration layers are about 10 to 100 grams per square meter. When electrically charged according to techniques described in, for example, the '507 patent, and when including fluorine atoms as mentioned in the Jones et al. patents, the basis weight may be about 20 to 40 g/m² and about 10 to 30 g/m², respectively.

An inner cover web can be used to provide a smooth surface for contacting the wearer's face, and an outer cover web can be used to entrap loose fibers in the mask body or for aesthetic reasons. The cover web typically does not provide any substantial filtering benefits to the filtering structure, although it can act as a pre-filter when disposed on the exterior (or upstream to) the filtration layer. To obtain a suitable degree of comfort, an inner cover web preferably has a comparatively low basis weight and is formed from comparatively fine fibers. More particularly, the cover web may be fashioned to have a basis weight of about 5 to 50 g/m2 (typically 10 to 30 g/m²), and the fibers are less than 3.5 denier (typically less than 2 denier, and more typically less than 1 denier but greater than 0.1). Fibers used in the cover web often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover web are blown microfiber (BMF) materials, particularly polyolefin BMF materials, for example polypropylene BMF materials (including polypropylene blends and also blends of polypropylene and polyethylene). A suitable process for producing BMF materials for a cover web is described in U.S. Pat. No. 4,013,816 to Sabee et al. The web may be formed by collecting the fibers on a smooth surface, typically a smooth-surfaced drum. Spun-bond fibers also may be used.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J. W. Suominen O Y of Nakila, Finland.

Cover webs that are used in the invention preferably have very few fibers protruding from the web surface after processing and therefore have a smooth outer surface. Examples of cover webs that may be used in the present invention are disclosed, for example, in U.S. Pat. No. 6,041,782 to Angadjivand, U.S. Pat. No. 6,123,077 to Bostock et al., and WO 96/28216A to Bostock et al.

A nose clip may be attached to the mask body to improve fit over the bridge of the wearer's nose. See U.S. Pat. Nos. 5,558,089 and Des. 412,573 to Castiglione.

An exhalation valve may be attached to the mask body to facilitate purging exhaled air from the interior gas space. The use of an exhalation valve may improve wearer comfort by rapidly removing the warm moist exhaled air from the mask interior. See, for example, U.S. Pat. Nos. 7,188,622, 7,028,689, and 7,013,895 to Martin et al.; U.S. Pat. Nos. 7,117,868, 6,854,463, 6,843,248, and 5,325,892 to Japuntich et al.; U.S. Pat. No. 6,883,518 to Mittelstadt et al.; and U.S. Pat. No. RE37,974 to Bowers. Essentially any exhalation valve that provides a suitable pressure drop and that can be properly secured to the frame may be used in connection with the present invention.

### EXAMPLE

Respirator Support Structure Manufacture

Samples of the respirator support structure were made using a standard injection molding process. Single cavity male and female molds, matching the geometry of the support structure shown in FIGS. 1-3 were manufactured at a tool manufacturer. At a relaxed state, or while the support structure was still on the mold, the support structure measured about 115 mm, top to bottom, and about 120 mm from side to side. The measurement was made along a direct line between the highest and lowest points on the perimeter and the outer edges of the side perimeter members, respectively while the respirator was in an unstressed state. The targeted thickness of the members that comprised the support structure was 2.5 millimeters. The transversely-extending members were given a trapezoidal cross-section to allow the support structure to be more easily removed from the mold. The cross-sectional area of the transversely-extending members ranged from about 2 to 5 mm². The flanges and buckles had the shape and configuration shown in U.S. Patent Application Ser. No. 60/994,644 entitled Buckle Having A Flexural Strap Attachment Member And Respirator Using Such Buckle, filed Sep. 20, 2007 (attorney docket number 63577US002). A polypropylene/thermoplastic elastomer mixture was fed into the extruder with a white pigment. Propylene 5724 from Total was used at 58 wt %; Septon™ 2063 from Kuraray at 40 wt %; and 2 wt % TiO₂ pigment.

Respirator Filtering Structure Manufacture

Respirator filtering structures were formed from two layers of nonwoven fibrous electret filter material that was 254 mm wide, laminated between one 50 grams per square meter (gsm) outer layer of white nonwoven fibrous spunbond material and one 22 gsm inner layer of white nonwoven fibrous spunbond material having the same width. Both layers of the nonwoven fibrous spunbond materials were made of polypropylene. The electret filter material was the standard filter material that is used in a 3M 8511 N95 respirator. The laminated web blank was cut into the 254 mm long pieces to form a square before being formed into a cup formation that mated with the support structure.

Other Respirator Components

Face seal: Standard 3M 4000 Series respirator face seal.

Nose clip: Standard 3M 8210 Plus N 95 Respirator nose clip.

Headband: Standard 3M 8210 Plus N 95 Respirator headband material but white in color. The Yellow pigment for 3M 8210 Plus respirator headband was removed.

The face seal was ultrasonically welded to the filtering structure, and the nose clip insert molded into the support structure. Two headbands were frictionally threaded through the buckles to an appropriate length.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent that there is a conflict or discrepancy between the disclosure in the incorporated document and the above specification, the above specification will control.

What is claimed is:

1. A filtering face-piece respirator that comprises:
(a) a mask body that comprises:
(i) a filtering structure;
(ii) a support structure that includes a perimeter member that is sized to enable a first buckle to be integrally joined thereto;
(iii) a first strap that is threaded through the first buckle.

2. The filtering face-piece respirator of claim 1, wherein the perimeter member includes at least one flange onto which the buckle is integrally joined.

3. The filtering face-piece respirator of claim 2, wherein the perimeter member further comprises a second flange on an opposing side of the support structure from the first flange, the second flange having a second buckle integrally secured thereto.

4. The filtering face-piece respirator of claim 3, wherein the perimeter member further comprises (iii) third and fourth flange members onto which third and fourth buckles are integrally secured; and (iv) a second strap that is threaded through the second and third buckles.

5. The filtering face-piece respirator of claim 1, wherein the support structure comprises a plurality of spaced transversely-extending plastic members that extend between first and second sides of the support structure.

6. The filtering face-piece respirator of claim 5, wherein the transversely-extending plastic members have a cross-sectional area of about 2 to 12 mm² and have a Stiffness in Flexure of about 75 to 300 MPa.

7. The filtering face-piece respirator of claim 5, wherein the transversely-extending plastic members have a cross-sectional area of about 4 to 8 mm² and have a Stiffness in Flexure of about 100 to 250 MPa.

8. The filtering face-piece respirator of claim 5, wherein the support structure further comprises a plurality of longitudinally-spaced transversely-extending plastic members.

9. The filtering face-piece respirator of claim 4, wherein the first and second straps are elastic straps.

10. The filtering face-piece respirator of claim 1, wherein the filtering structure comprises a non-woven web that includes electrically-charged microfibers and first and second cover webs located on opposing sides of the non-woven web of electrically-charged microfibers.

11. The filtering face-piece respirator of claim 1, wherein the buckle comprises first and second slots and a cinch bar.

12. The filtering face-piece respirator of claim 11, wherein the strap is threaded through the first and second slots such that strap length behind the wearer's head can be decreased by pulling on a free end of the strap.

13. The filtering face-piece respirator of claim 12, wherein the strap frictionally engages the cinch bar to preclude the strap from being pulled through the buckle when tension is exerted on the strap between the first and second sides of the mask body.

14. A method of making a filtering face-piece respirator, which method comprises:
(a) providing a mask body that comprises a support structure that has at least one buckle integrally joined thereto;
(b) supporting a filtering structure within the mask body; and
(c) providing a strap that can be threaded through the buckle and that can be adjusted in length.

15. The method of claim 14, wherein the support structure includes transversely-extending members that extend from a first side of the mask body to a second side.

16. The method of claim 14, wherein the buckle comprises first and second slots and a cinch bar, the strap being threaded through the first and second slots.

17. The method of claim 14, wherein the buckle comprises first and second slots and a cinch bar, the strap being threaded through the first and second slots.

18. A method of making a filtering face-peace respirator, which method comprises:
(a) providing a mask body that comprises a support structure that has at least one buckle integrally joined thereto;
(b) supporting a filtering structure within the mask body; and
(c) providing a strap that can be threaded through the buckle and that can be adjusted in length between the first and second sides of the mask body, wherein the buckle includes first and second slots and a cinch bar and wherein the strap frictionally engages the cinch bar to be resistant to being pulled through the first and second slots when tension is exerted upon the strap between the first and second sides of the mask body.
